(19) United States
(12) Patent Application Publication
(10) Pub. No.: US 2025/0069253 A1
(43) Pub. Date: Feb. 27, 2025

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Masahiko SUGIMOTO, Saitama-shi (JP); Tetsuya FUJIKAWA, Saitama-shi (JP); Tomoharu SHIMADA, Saitama-shi (JP)

(73) Assignee: FUJIFILM Corporation, Tokyo (JP)

(21) Appl. No.: 18/948,398

(22) Filed: Nov. 14, 2024

Related U.S. Application Data
(63) Continuation of application No. PCT/JP2023/016499, filed on Apr. 26, 2023.

(30) Foreign Application Priority Data
May 31, 2022 (JP) 2022-088615

(51) Int. Cl. G06T 7/70; G06F 3/14; G06V 20/52

(52) U.S. Cl. CPC G06T 7/70; G06F 3/14; G06V 20/52; G06T 2207/30242

(57) ABSTRACT

An information processing apparatus includes a processor, and the processor is configured to: acquire first position information of an imaging target position associated with a captured image captured by an imaging system and second position information of a terminal device obtained by the terminal device in an imaging region of the imaging system; and generate first data based on the first position information and the second position information.

### CROSS REFERENCE TO RELATED APPLICATION

This is a continuation of International Application No. PCT/JP2023/016499 filed on Apr. 26, 2023, and claims priority from Japanese Patent Application No. 2022-088615 filed on May 31, 2022, the entire disclosures of which are incorporated herein by reference.

### BACKGROUND OF THE INVENTION

### 1. Field of the Invention

The present invention relates to an information processing apparatus, an information processing method, and a computer readable medium storing an information processing program.

### 2. Description of the Related Art

JP2014-078150A discloses a wide area surveillance system that generates suspicious person information including a notification destination based on position information of a surveillance camera associated with a captured image and latitude and longitude of a mobile terminal of a user. JP2013-246570A discloses an information processing system that stores history data of position information of a mobile terminal in a database server, obtains map information corresponding to the history data of the position information from a map search service in a process of obtaining a behavior history of the position information of the mobile terminal from a communication terminal, generates map information in which the history data is superimposed on the map information, and outputs the map information to the communication terminal. JP2019-124858A discloses a control device of an imaging apparatus that considers an error of a latitude and longitude value and specifies a range in which a true latitude and longitude value is included based on an actual latitude and longitude value.

### SUMMARY OF THE INVENTION

One embodiment according to the technique of the present disclosure provides an information processing apparatus, an information processing method, and a computer readable medium storing an information processing program that can utilize position information of an imaging target associated with a captured image and position information obtained by a terminal device.

(1)

An information processing apparatus comprising:
a processor,
in which the processor is configured to:
   acquire first position information of an imaging target position associated with a captured image captured by an imaging system and second position information of a terminal device obtained by the terminal device in an imaging region of the imaging system; and
   generate first data based on the first position information and the second position information.

(2)

The information processing apparatus according to (1),
in which the terminal device is a terminal device provided in a moving object included in the captured image.

(3)

The information processing apparatus according to (1) or (2),
in which the first data includes instruction information in which the terminal device is set as a transmission destination.

(4)

The information processing apparatus according to (3),
in which the processor is configured to:
   acquire the second position information for a plurality of the terminal devices; and
   generate the instruction information in which a terminal device, among the plurality of terminal devices, of which the second position information is included in a range based on the first position information, is set as a transmission destination.

(5)

The information processing apparatus according to (4),
in which the processor is configured to set the range based on the first position information and zoom information of the imaging system.

(6)

The information processing apparatus according to (4) or (5),
in which the processor is configured to set the range based on the first position information and the number of the moving objects having the terminal device, which are detected from the captured image.

(7)

The information processing apparatus according to any one of (3) to (6),
in which the processor is configured to, in a case where information indicating an abnormality of a possessor of the terminal device is received from the terminal device, perform control of displaying, on the display device, the captured image showing a region of the imaging region indicated by the second position information.

(8)

The information processing apparatus according to (1) or (2),
in which the first data is information related to a movement history of the moving object having the terminal device.

(9)

The information processing apparatus according to (8),
in which the processor is configured to, as information related to the movement history, generate an image obtained by superimposing an image showing the movement history of the moving object on the captured image, based on the first position information and the second position information.

(10)

The information processing apparatus according to any one of (1) to (9),
in which the processor is configured to perform control of displaying, on the display device, a wide area image showing the imaging region and a detailed image showing a range narrower than the wide area image in the imaging region at a higher magnification than the wide area image.

(11)

The information processing apparatus according to any one of (1) to (10),
in which the imaging system includes an imaging apparatus that obtains the captured image by imaging and a revolution mechanism that revolves the imaging apparatus, and
the first position information is associated with information indicating a revolution state of the imaging apparatus by the revolution mechanism in a case where the captured image is obtained by the imaging system.

(12)

An information processing method comprising:
via a processor of an information processing apparatus,
acquiring first position information of an imaging target position associated with a captured image captured by an imaging system and second position information of a terminal device obtained by the terminal device in an imaging region of the imaging system; and
generating first data based on the first position information and the second position information.

(13)

An information processing program, stored in a computer readable medium, causing a processor of an information processing apparatus to execute a process comprising:
acquiring first position information of an imaging target position associated with a captured image captured by an imaging system and second position information of a terminal device obtained by the terminal device in an imaging region of the imaging system; and
generating first data based on the first position information and the second position information.

According to the present invention, it is possible to provide an information processing apparatus, an information processing method, and a computer readable medium storing an information processing program that can utilize the position information of the imaging target associated with the captured image and the position information obtained by the terminal device.

### BRIEF DESCRIPTION OF THE DRAWINGS

FIG. 1 is a diagram showing an example of an imaging system 1 equipped with a control device of the present embodiment.

FIG. 2 is a diagram showing an example of revolution of a surveillance camera 10 in a pitch direction by a revolution mechanism 16.

FIG. 3 is a diagram showing an example of the revolution of the surveillance camera 10 in a yaw direction by the revolution mechanism 16.

FIG. 4 is a block diagram showing an example of a configuration of an optical system and an electrical system of the surveillance camera 10.

FIG. 5 is a diagram showing an example of a configuration of an electrical system of the revolution mechanism 16 and a management apparatus 11.

FIG. 6 is a diagram showing an example of an image displayed by the management apparatus 11.

FIG. 7 is a diagram showing an example of a hardware configuration of a terminal device possessed by a worker in a surveillance target region E1.

FIG. 8 is a flowchart showing an example of a process by the management apparatus 11.

FIG. 9 is a diagram showing Modification Example 1 of the imaging system 1.

FIG. 10 is a diagram showing an example of a configuration of the electrical system of the management apparatus 11 shown in FIG. 9.

FIG. 11 is a diagram showing an example of an image displayed by the management apparatus 11 in configurations shown in FIGS. 9 and 10.

FIG. 12 is a diagram showing Modification Example 2 of the imaging system 1.

FIG. 13 is a diagram showing an example of a configuration of the electrical system of the management apparatus 11 shown in FIG. 12.

FIG. 14 is a diagram showing an example of a checking processing of a person in poor physical condition, an injured person, or the like.

FIG. 15 is a flowchart showing an example of a process by the management apparatus 11 of Embodiment 2.

FIG. 16 is a diagram showing an example of a display of a wide area image 90 on which a movement history image is superimposed.

FIG. 17 is a diagram showing an example of an image displayed by the management apparatus 11 in a case where a configuration of the imaging system 1 of Embodiment 2 is the configurations shown in FIGS. 9 and 10.

FIG. 18 is a diagram showing an example of an aspect in which the information processing program of an operation control example is installed in the control device 60 of the management apparatus 11 from a storage medium in which the information processing program is stored.

### DESCRIPTION OF THE PREFERRED EMBODIMENTS

Hereinafter, an example of an embodiment of the present invention will be described with reference to the drawings.

### Embodiment 1

### Imaging System of Embodiment

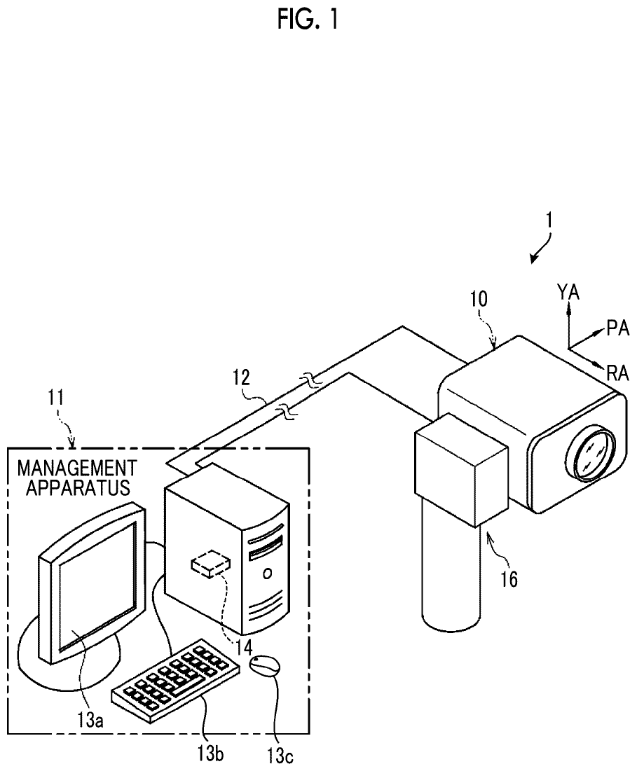

FIG. 1 is a diagram showing an example of an imaging system 1 equipped with a control device of the present embodiment. As shown in FIG. 1 as an example, the imaging system 1 includes a surveillance camera 10, a management apparatus 11, and a revolution mechanism 16. The surveillance camera 10 and the revolution mechanism 16 are examples of an imaging system according to the embodiment of the present invention. The management apparatus 11 is an example of an information processing apparatus according to the embodiment of the present invention.

The surveillance camera 10 is installed in an indoor or outdoor post or wall, a part (for example, rooftop) of a building, or the like, via the revolution mechanism 16, to capture an imaging target that is a subject. The surveillance camera 10 transmits, to the management apparatus 11 via a communication line 12, a captured image obtained by the capturing and imaging information related to the capturing of the captured image.

The management apparatus 11 comprises a display 13a, a keyboard 13b, a mouse 13c, and a secondary storage device 14. Examples of the display 13a include a liquid crystal display, a plasma display, an organic electro-luminescence (EL) display, and a cathode ray tube (CRT) display. The display 13a is an example of a display device according to the embodiment of the present invention.

An example of the secondary storage device 14 includes a hard disk drive (HDD). The secondary storage device 14 is not limited to the HDD, and may be a non-volatile memory such as a flash memory, a solid state drive (SSD), or an electrically erasable and programmable read only memory (EEPROM).

The management apparatus 11 receives the captured image or the imaging information, which is transmitted from the surveillance camera 10, and displays the received captured image or imaging information on the display 13a or stores the received captured image or imaging information in the secondary storage device 14.

The management apparatus 11 performs imaging control of controlling the imaging performed by the surveillance camera 10. For example, the management apparatus 11 communicates with the surveillance camera 10 via the communication line 12 to perform the imaging control. The imaging control is to set, to the surveillance camera 10, an imaging parameter for the imaging performed by the surveillance camera 10 and to cause the surveillance camera 10 to execute the imaging. The imaging parameters include a parameter related to exposure, a parameter of a zoom position, and the like.

In addition, the management apparatus 11 controls the revolution mechanism 16 to perform control of the imaging direction (pan and tilt) of the surveillance camera 10. For example, the management apparatus 11 sets the revolution direction, the revolution amount, the revolution speed, and the like of the surveillance camera 10 in response to an operation of the keyboard 13b and the mouse 13c, or a touch operation of the display 13a on the screen.

### <Revolution of Surveillance Camera 10 by Revolution Mechanism 16>

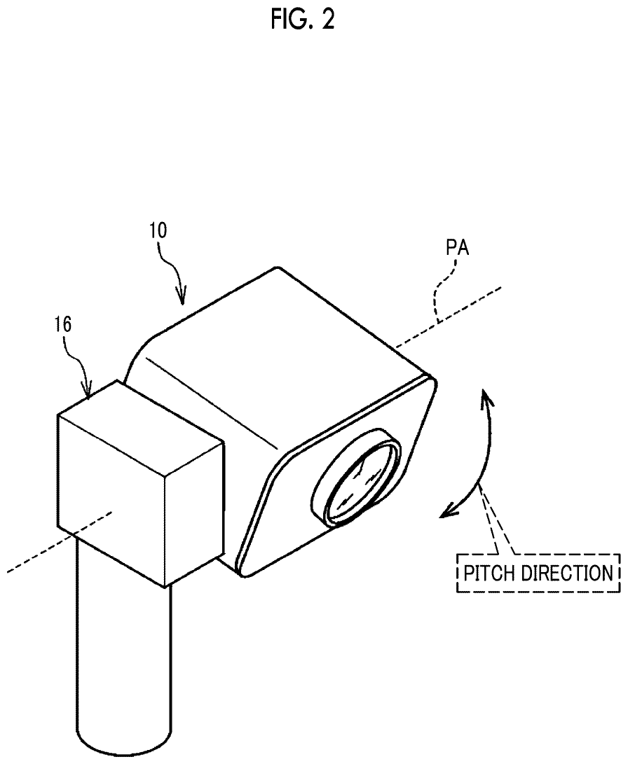

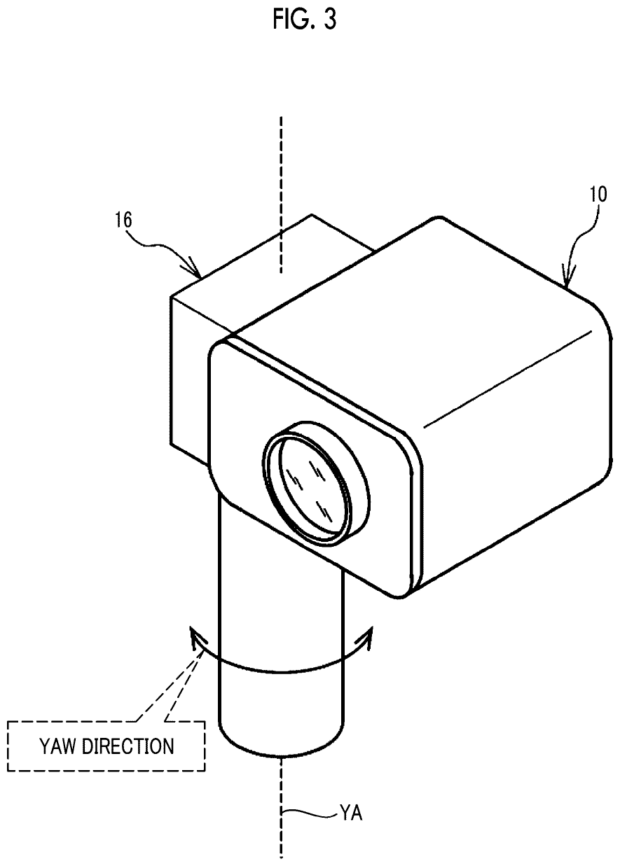

FIG. 2 is a diagram showing an example of revolution of the surveillance camera 10 in a pitch direction by the revolution mechanism 16. FIG. 3 is a diagram showing an example of the revolution of the surveillance camera 10 in a yaw direction by the revolution mechanism 16. The surveillance camera 10 is attached to the revolution mechanism 16. The revolution mechanism 16 enables the surveillance camera 10 to revolve.

Specifically, the revolution mechanism 16 is a two-axis revolution mechanism that enables the surveillance camera 10 to revolve in a revolution direction (pitch direction) that intersects the yaw direction and that has a pitch axis PA as a central axis, as shown in FIG. 2 as an example, and in a revolution direction (yaw direction) that has a yaw axis YA as a central axis, as shown in FIG. 3 as an example. An example is shown in which the two-axis revolution mechanism is used as the revolution mechanism 16 according to the present embodiment, but the technique of the present disclosure is not limited thereto. A three-axis revolution mechanism or a one-axis revolution mechanism may be used.

### <Configuration of Optical System and Electrical System of Surveillance Camera 10>

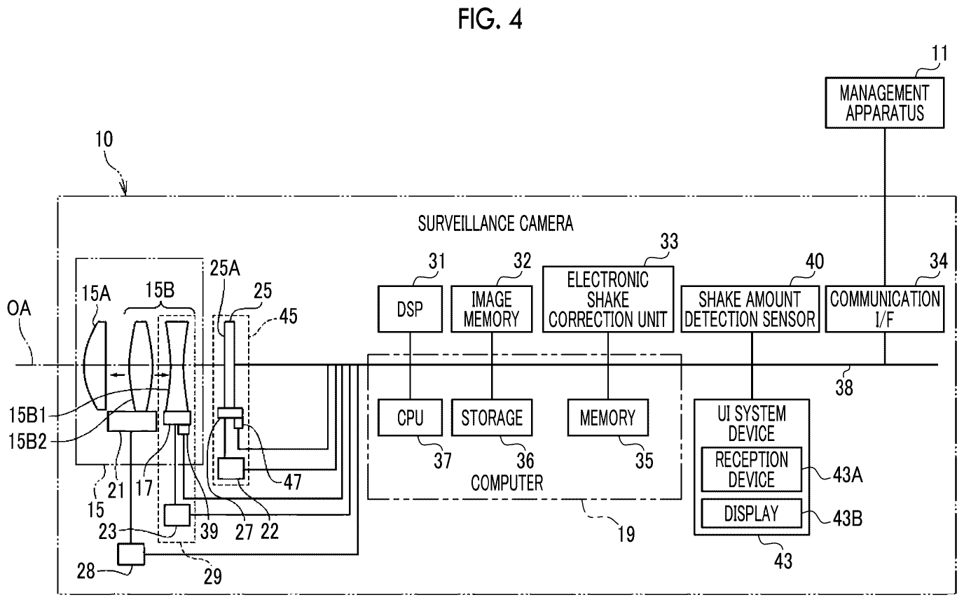

FIG. 4 is a block diagram showing an example of a configuration of an optical system and an electrical system of the surveillance camera 10. As shown in FIG. 4 as an example, the surveillance camera 10 comprises an optical system 15 and an imaging element 25. The imaging element 25 is located after the optical system 15. The optical system 15 comprises an objective lens 15A and a lens group 15B. The objective lens 15A and the lens group 15B are disposed, along an optical axis OA of the optical system 15, over a light-receiving surface 25A side (image side) of the imaging element 25 from a target subject side (object side) in an order of the objective lens 15A and the lens group 15B. The lens group 15B includes an anti-vibration lens 15B1, a focus lens (not illustrated), a zoom lens 15B2, and the like. The zoom lens 15B2 is movably supported along the optical axis OA by a lens actuator 21 described below. The anti-vibration lens 15B1 is movably supported in a direction orthogonal to the optical axis OA by a lens actuator 17 described below.

An increase in a focal length by the zoom lens 15B2 sets the surveillance camera 10 on a telephoto side, and thus an angle of view is decreased (imaging range is narrowed). A decrease in the focal length by the zoom lens 15B2 sets the surveillance camera 10 on a wide angle side, and thus the angle of view is increased (imaging range is widened).

Various lenses (not illustrated) may be provided as the optical system 15 in addition to the objective lens 15A and the lens group 15B. Furthermore, the optical system 15 may comprise a stop. Positions of the lenses, the lens group, and the stop included in the optical system 15 are not limited. For example, the technique of the present disclosure is also effective for positions different from the positions shown in FIG. 4.

The anti-vibration lens 15B1 is movable in a direction perpendicular to the optical axis OA, and the zoom lens 15B2 is movable along the optical axis OA.

The optical system 15 comprises the lens actuators 17 and 21. The lens actuator 17 causes force that fluctuates in a direction perpendicular to an optical axis of the anti-vibration lens 15B 1 to act on the anti-vibration lens 15B1. The lens actuator 17 is controlled by an optical image stabilizer (OIS) driver 23. With the drive of the lens actuator 17 under the control of the OIS driver 23, the position of the anti-vibration lens 15B1 fluctuates in the direction perpendicular to the optical axis OA.

The lens actuator 21 causes force that moves along the optical axis OA of the optical system 15 to act on the zoom lens 15B2. The lens actuator 21 is controlled by a lens driver 28. With the drive of the lens actuator 21 under the control of the lens driver 28, the position of the zoom lens 15B2 moves along the optical axis OA. With the movement of the position of the zoom lens 15B2 along the optical axis OA, the focal length of the surveillance camera 10 changes.

For example, in a case where a contour of the captured image is a rectangle having a short side in the direction of the pitch axis PA and having a long side in the direction of the yaw axis YA, the angle of view in the direction of the pitch axis PA is narrower than the angle of view in the direction of the yaw axis YA and the angle of view of a diagonal line.

With the optical system 15 configured in such a manner, light indicating an imaging region forms an image on the light-receiving surface 25A of the imaging element 25, and the imaging region is imaged by the imaging element 25.

By the way, a vibration provided to the surveillance camera 10 includes, in an outdoor situation, a vibration caused by passage of automobiles, a vibration caused by wind, a vibration caused by a road construction, and the like, and includes, in an indoor situation, a vibration caused by an air conditioner operation, a vibration caused by comings and goings of people, and the like. Thus, in the surveillance camera 10, a shake occurs due to the vibration provided to the surveillance camera 10 (hereinafter also simply referred to as “vibration”).

In the present embodiment, the term “shake” refers to a phenomenon, in the surveillance camera 10, in which a target subject image on the light-receiving surface 25A of the imaging element 25 fluctuates due to a change in positional relationship between the optical axis OA and the light-receiving surface 25A. In other words, it can be said that the term “shake” is a phenomenon in which an optical image, which is obtained by the image forming on the light-receiving surface 25A, fluctuates due to a tilt of the optical axis OA caused by the vibration provided to the surveillance camera 10. The fluctuation of the optical axis OA means that the optical axis OA is tilted with respect to, for example, a reference axis (for example, the optical axis OA before the shake occurs). Hereinafter, the shake that occurs due to the vibration will be simply referred to as “shake”.

The shake is included in the captured image as a noise component and affects image quality of the captured image. In order to remove the noise component included in the captured image due to the shake, the surveillance camera 10 comprises a lens-side shake correction mechanism 29, an imaging element-side shake correction mechanism 45, and an electronic shake correction unit 33, which are used for shake correction.

The lens-side shake correction mechanism 29 and the imaging element-side shake correction mechanism 45 are mechanical shake correction mechanisms. The mechanical shake correction mechanism is a mechanism that corrects the shake by applying, to a shake correction element (for example, anti-vibration lens 15B1 and/or imaging element 25), power generated by a driving source such as a motor (for example, voice coil motor) to move the shake correction element in a direction perpendicular to an optical axis of an imaging optical system.

Specifically, the lens-side shake correction mechanism 29 is a mechanism that corrects the shake by applying, to the anti-vibration lens 15B1, the power generated by the driving source such as the motor (for example, voice coil motor) to move the anti-vibration lens 15B1 in the direction perpendicular to the optical axis of the imaging optical system. The imaging element-side shake correction mechanism 45 is a mechanism that corrects the shake by applying, to the imaging element 25, the power generated by the driving source such as the motor (for example, voice coil motor) to move the imaging element 25 in the direction perpendicular to the optical axis of the imaging optical system. The electronic shake correction unit 33 performs image processing on the captured image based on a shake amount to correct the shake. That is, the shake correction unit (shake correction component) mechanically or electronically corrects the shake using a hardware configuration and/or a software configuration. The mechanical shake correction refers to the shake correction implemented by mechanically moving the shake correction element, such as the anti-vibration lens 15B1 and/or the imaging element 25, using the power generated by the driving source such as the motor (for example, voice coil motor). The electronic shake correction refers to the shake correction implemented by performing, for example, the image processing by a processor.

As shown in FIG. 4 as an example, the lens-side shake correction mechanism 29 comprises the anti-vibration lens 15B1, the lens actuator 17, the OIS driver 23, and a position sensor 39.

As a method of correcting the shake by the lens-side shake correction mechanism 29, various well-known methods can be employed. In the present embodiment, as the method of correcting the shake, a shake correction method is employed in which the anti-vibration lens 15B1 is caused to move based on the shake amount detected by a shake amount detection sensor 40 (described below). Specifically, the anti-vibration lens 15B1 is caused to move, by an amount with which the shake cancels, in a direction of canceling the shake to correct the shake.

The lens actuator 17 is attached to the anti-vibration lens 15B1. The lens actuator 17 is a shift mechanism equipped with the voice coil motor and drives the voice coil motor to cause the anti-vibration lens 15B1 to fluctuate in the direction perpendicular to the optical axis of the anti-vibration lens 15B1. Here, as the lens actuator 17, the shift mechanism equipped with the voice coil motor is employed, but the technique of the present disclosure is not limited thereto. Instead of the voice coil motor, another power source such as a stepping motor or a piezo element may be employed.

The lens actuator 17 is controlled by the OIS driver 23. With the drive of the lens actuator 17 under the control of the OIS driver 23, the position of the anti-vibration lens 15B1 mechanically fluctuates in a two-dimensional plane perpendicular to the optical axis OA.

The position sensor 39 detects a current position of the anti-vibration lens 15B1 and outputs a position signal indicating the detected current position. Here, as an example of the position sensor 39, a device including a Hall element is employed. Here, the current position of the anti-vibration lens 15B1 refers to a current position in an anti-vibration lens two-dimensional plane. The anti-vibration lens two-dimensional plane refers to a two-dimensional plane perpendicular to the optical axis of the anti-vibration lens 15B1. In the present embodiment, the device including the Hall element is employed as an example of the position sensor 39, but the technique of the present disclosure is not limited thereto. Instead of the Hall element, a magnetic sensor, a photo sensor, or the like may be employed.

The lens-side shake correction mechanism 29 causes the anti-vibration lens 15B1 to move along at least one of the direction of the pitch axis PA or the direction of the yaw axis YA in an actually imaged range to correct the shake. That is, the lens-side shake correction mechanism 29 causes the anti-vibration lens 15B1 to move in the anti-vibration lens two-dimensional plane by a movement amount corresponding to the shake amount to correct the shake.

The imaging element-side shake correction mechanism 45 comprises the imaging element 25, a body image stabilizer (BIS) driver 22, an imaging element actuator 27, and a position sensor 47.

In the same manner as the method of correcting the shake by the lens-side shake correction mechanism 29, various well-known methods can be employed as the method of correcting the shake by the imaging element-side shake correction mechanism 45. In the present embodiment, as the method of correcting the shake, a shake correction method is employed in which the imaging element 25 is caused to move based on the shake amount detected by the shake amount detection sensor 40. Specifically, the imaging element 25 is caused to move, by an amount with which the shake cancels, in a direction of canceling the shake to correct the shake.

The imaging element actuator 27 is attached to the imaging element 25. The imaging element actuator 27 is a shift mechanism equipped with the voice coil motor and drives the voice coil motor to cause the imaging element 25 to fluctuate in the direction perpendicular to the optical axis of the anti-vibration lens 15B1. Here, as the imaging element actuator 27, the shift mechanism equipped with the voice coil motor is employed, but the technique of the present disclosure is not limited thereto. Instead of the voice coil motor, another power source such as a stepping motor or a piezo element may be employed.

The imaging element actuator 27 is controlled by the BIS driver 22. With the drive of the imaging element actuator 27 under the control of the BIS driver 22, the position of the imaging element 25 mechanically fluctuates in the direction perpendicular to the optical axis OA.

The position sensor 47 detects a current position of the imaging element 25 and outputs a position signal indicating the detected current position. Here, as an example of the position sensor 47, a device including a Hall element is employed. Here, the current position of the imaging element 25 refers to a current position in an imaging element two-dimensional plane. The imaging element two-dimensional plane refers to a two-dimensional plane perpendicular to the optical axis of the anti-vibration lens 15B1. In the present embodiment, the device including the Hall element is employed as an example of the position sensor 47, but the technique of the present disclosure is not limited thereto. Instead of the Hall element, a magnetic sensor, a photo sensor, or the like may be employed.

The surveillance camera 10 comprises a computer 19, a digital signal processor (DSP) 31, an image memory 32, the electronic shake correction unit 33, a communication I/F 34, the shake amount detection sensor 40, and a user interface (UI) system device 43. The computer 19 comprises a memory 35, a storage 36, and a central processing unit (CPU) 37.

The imaging element 25, the DSP 31, the image memory 32, the electronic shake correction unit 33, the communication I/F 34, the memory 35, the storage 36, the CPU 37, the shake amount detection sensor 40, and the UI system device 43 are connected to a bus 38. Further, the OIS driver 23 is connected to the bus 38. In the example shown in FIG. 4, one bus is illustrated as the bus 38 for convenience of illustration, but a plurality of buses may be used. The bus 38 may be a serial bus or may be a parallel bus such as a data bus, an address bus, and a control bus.

The memory 35 temporarily stores various types of information, and is used as a work memory. A random access memory (RAM) is exemplified as an example of the memory 35, but the present invention is not limited thereto. Another type of storage device may be used. The storage 36 stores various programs for the surveillance camera 10. The CPU 37 reads out various programs from the storage 36 and executes the readout various programs on the memory 35 to control the entire surveillance camera 10. An example of the storage 36 includes a flash memory, SSD, EEPROM, HDD, or the like. Further, for example, various non-volatile memories such as a magnetoresistive memory and a ferroelectric memory may be used instead of the flash memory or together with the flash memory.

The imaging element 25 is a complementary metal oxide semiconductor (CMOS) type image sensor. The imaging element 25 images a target subject at a predetermined frame rate under an instruction of the CPU 37. The term “predetermined frame rate” described herein refers to, for example, several tens of frames/second to several hundreds of frames/second. The imaging element 25 may incorporate a control device (imaging element control device). In this case, the imaging element control device performs detailed control inside the imaging element 25 in response to the imaging instruction output by the CPU 37. Further, the imaging element 25 may image the target subject at the predetermined frame rate under an instruction of the DSP 31. In this case, the imaging element control device performs detailed control inside the imaging element 25 in response to the imaging instruction output by the DSP 31. The DSP 31 may be referred to as an image signal processor (ISP).

The light-receiving surface 25A of the imaging element 25 is formed by a plurality of photosensitive pixels (not illustrated) arranged in a matrix. In the imaging element 25, each photosensitive pixel is exposed, and photoelectric conversion is performed for each photosensitive pixel. A charge obtained by performing the photoelectric conversion for each photosensitive pixel corresponds to an analog imaging signal indicating the target subject. Here, a plurality of photoelectric conversion elements (for example, photoelectric conversion elements in which color filters are disposed) having sensitivity to visible light are employed as the plurality of photosensitive pixels. In the imaging element 25, the photoelectric conversion element having sensitivity to R (red) light (for example, photoelectric conversion element in which an R filter corresponding to R is disposed), the photoelectric conversion element having sensitivity to G (green) light (for example, photoelectric conversion element in which a G filter corresponding to G is disposed), and the photoelectric conversion element having sensitivity to B (blue) light (for example, photoelectric conversion element in which a B filter corresponding to B is disposed) are employed as the plurality of photoelectric conversion elements. In the surveillance camera 10, these photosensitive pixels are used to perform the imaging based on the visible light (for example, light on a short wavelength side of about 700 nanometers or less). However, the present embodiment is not limited thereto. The imaging based on infrared light (for example, light on a wavelength side longer than about 700 nanometers) may be performed. In this case, the plurality of photoelectric conversion elements having sensitivity to the infrared light may be used as the plurality of photosensitive pixels. In particular, for example, an InGaAs sensor and/or a simulation of type-II quantum well (T2SL) sensor may be used for short-wavelength infrared (SWIR) imaging.

The imaging element 25 performs signal processing such as analog/digital (A/D) conversion on the analog imaging signal to generate a digital image that is a digital imaging signal. The imaging element 25 is connected to the DSP 31 via the bus 38 and outputs the generated digital image to the DSP 31 in units of frames via the bus 38.

Here, the CMOS image sensor is exemplified for description as an example of the imaging element 25, but the technique of the present disclosure is not limited thereto. A charge coupled device (CCD) image sensor may be employed as the imaging element 25. In this case, the imaging element 25 is connected to the bus 38 via an analog front end (AFE) (not illustrated) that incorporates a CCD driver. The AFE performs the signal processing, such as the A/D conversion, on the analog imaging signal obtained by the imaging element 25 to generate the digital image and output the generated digital image to the DSP 31. The CCD image sensor is driven by the CCD driver incorporated in the AFE. Of course, the CCD driver may be independently provided.

The DSP 31 performs various types of digital signal processing on the digital image. For example, the various types of digital signal processing refer to demosaicing processing, noise removal processing, gradation correction processing, and color correction processing. The DSP 31 outputs the digital image after the digital signal processing to the image memory 32 for each frame. The image memory 32 stores the digital image from the DSP 31.

The shake amount detection sensor 40 is, for example, a device including a gyro sensor, and detects the shake amount of the surveillance camera 10. In other words, the shake amount detection sensor 40 detects the shake amount in each of a pair of axial directions. The gyro sensor detects a rotational shake amount around respective axes (refer to FIG. 1) of the pitch axis PA, the yaw axis YA, and a roll axis RA (axis parallel to the optical axis OA). The shake amount detection sensor 40 converts the rotational shake amount around the pitch axis PA and the rotational shake amount around the yaw axis YA, which are detected by the gyro sensor, into the shake amount in a two-dimensional plane parallel to the pitch axis PA and the yaw axis YA to detect the shake amount of the surveillance camera 10.

Here, the gyro sensor is exemplified as an example of the shake amount detection sensor 40, but this is merely an example. The shake amount detection sensor 40 may be an acceleration sensor. The acceleration sensor detects the shake amount in the two-dimensional plane parallel to the pitch axis PA and the yaw axis YA. The shake amount detection sensor 40 outputs the detected shake amount to the CPU 37.

Further, although the form example is shown in which the shake amount is detected by a physical sensor called the shake amount detection sensor 40, the technique of the present disclosure is not limited thereto. For example, a movement vector obtained by comparing preceding and succeeding captured images in time series, which are stored in the image memory 32, may be used as the shake amount. Further, the shake amount to be finally used may be derived based on the shake amount detected by the physical sensor and the movement vector obtained by the image processing.

The CPU 37 acquires the shake amount detected by the shake amount detection sensor 40 and controls the lens-side shake correction mechanism 29, the imaging element-side shake correction mechanism 45, and the electronic shake correction unit 33 based on the acquired shake amount. The shake amount detected by the shake amount detection sensor 40 is used for the shake correction by each of the lens-side shake correction mechanism 29 and the electronic shake correction unit 33.

The electronic shake correction unit 33 is a device including an application specific integrated circuit (ASIC). The electronic shake correction unit 33 performs the image processing on the captured image in the image memory 32 based on the shake amount detected by the shake amount detection sensor 40 to correct the shake.

Here, the device including the ASIC is exemplified as the electronic shake correction unit 33, but the technique of the present disclosure is not limited thereto. For example, a device including a field programmable gate array (FPGA) or a programmable logic device (PLD) may be used. Further, for example, the electronic shake correction unit 33 may be a device including a plurality of ASICs, FPGAs, and PLDs. Further, a computer including a CPU, a storage, and a memory may be employed as the electronic shake correction unit 33. The number of CPUs may be singular or plural. Further, the electronic shake correction unit 33 may be implemented by a combination of a hardware configuration and a software configuration.

The communication I/F 34 is, for example, a network interface, and controls transmission of various types of information to and from the management apparatus 11 via a network. The network is, for example, a wide area network (WAN) or a local area network (LAN), such as the Internet. The communication I/F 34 performs communication between the surveillance camera 10 and the management apparatus 11.

The UI system device 43 comprises a reception device 43A and a display 43B. The reception device 43A is, for example, a hard key, a touch panel, and the like, and receives various instructions from a user. The CPU 37 acquires various instructions received by the reception device 43A and operates in response to the acquired instructions.

The display 43B displays various types of information under the control of the CPU 37. Examples of the various types of information displayed on the display 43B include a content of various instructions received by the reception device 43A and the captured image.

### <Configuration of Electrical System of Revolution Mechanism 16 and Management Apparatus 11>

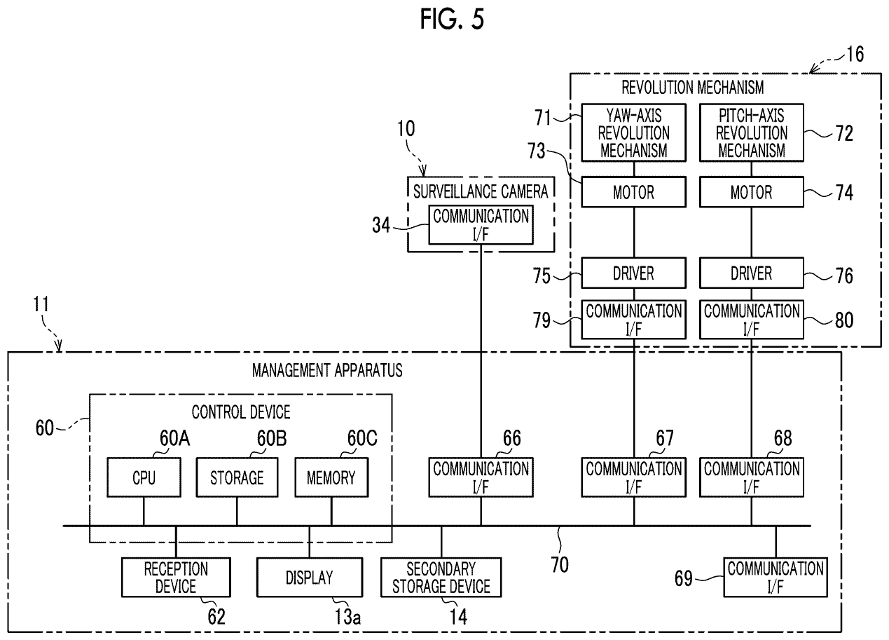

FIG. 5 is a diagram showing an example of a configuration of an electrical system of the revolution mechanism 16 and the management apparatus 11. As shown in FIG. 5 as an example, the revolution mechanism 16 comprises a yaw-axis revolution mechanism 71, a pitch-axis revolution mechanism 72, a motor 73, a motor 74, a driver 75, a driver 76, and communication I/Fs 79 and 80.

The yaw-axis revolution mechanism 71 causes the surveillance camera 10 to revolve in the yaw direction. The motor 73 is driven to generate the power under the control of the driver 75. The yaw-axis revolution mechanism 71 receives the power generated by the motor 73 to cause the surveillance camera 10 to revolve in the yaw direction. The pitch-axis revolution mechanism 72 causes the surveillance camera 10 to revolve in the pitch direction. The motor 74 is driven to generate the power under the control of the driver 76. The pitch-axis revolution mechanism 72 receives the power generated by the motor 74 to cause the surveillance camera 10 to revolve in the pitch direction.

The communication I/Fs 79 and 80 are, for example, network interfaces, and control transmission of various types of information to and from the management apparatus 11 via the network. The network is, for example, a WAN or a LAN, such as the Internet. The communication I/Fs 79 and 80 performs communication between the revolution mechanism 16 and the management apparatus 11.

As shown in FIG. 5 as an example, the management apparatus 11 comprises the display 13a, the secondary storage device 14, a control device 60, a reception device 62, and communication I/Fs 66, 67, and 68. The control device 60 comprises a CPU 60A, a storage 60B, and a memory 60C. The CPU 60A is an example of the processor in the embodiment of the present invention.

Each of the reception device 62, the display 13a, the secondary storage device 14, the CPU 60A, the storage 60B, the memory 60C, and the communication I/F 66 is connected to a bus 70. In the example shown in FIG. 5, one bus is illustrated as the bus 70 for convenience of illustration, but a plurality of buses may be used. The bus 70 may be a serial bus or may be a parallel bus including a data bus, an address bus, a control bus, and the like.

The memory 60C temporarily stores various types of information and is used as the work memory. An example of the memory 60C includes the RAM, but the present invention is not limited thereto. Another type of storage device may be employed. Various programs for the management apparatus 11 (hereinafter simply referred to as “programs for management apparatus”) are stored in the storage 60B.

The CPU 60A reads out the program for management apparatus from the storage 60B and executes the readout program for management apparatus on the memory 60C to control the entire management apparatus 11. The program for management apparatus includes an information processing program according to the embodiment of the present invention.

The communication I/F 66 is, for example, a network interface. The communication I/F 66 is communicably connected to the communication I/F 34 of the surveillance camera 10 via the network, and controls transmission of various types of information to and from the surveillance camera 10. The communication I/Fs 67 and 68 are, for example, network interfaces. The communication I/F 67 is communicably connected to the communication I/F 79 of the revolution mechanism 16 via the network, and controls transmission of various types of information to and from the yaw-axis revolution mechanism 71. The communication I/F 68 is communicably connected to the communication I/F 80 of the revolution mechanism 16 via the network, and controls transmission of various types of information to and from the pitch-axis revolution mechanism 72.

The CPU 60A receives the captured image, the imaging information, and the like from the surveillance camera 10 via the communication I/F 66 and the communication I/F 34.

The CPU 60A controls the driver 75 and the motor 73 of the revolution mechanism 16 via the communication I/F 67 and the communication I/F 79 to control a revolution operation of the yaw-axis revolution mechanism 71. Further, the CPU 60A controls the driver 76 and the motor 74 of the revolution mechanism 16 via the communication I/F 68 and the communication I/F 80 to control the revolution operation of the pitch-axis revolution mechanism 72.

The reception device 62 is, for example, the keyboard 13b, the mouse 13c, and a touch panel of the display 13a, and receives various instructions from the user. The CPU 60A acquires various instructions received by the reception device 62 and operates in response to the acquired instructions. For example, in a case where the reception device 62 receives a processing content for the surveillance camera 10 and/or the revolution mechanism 16, the CPU 60A causes the surveillance camera 10 and/or the revolution mechanism 16 to operate in accordance with an instruction content received by the reception device 62.

The display 13a displays various types of information under the control of the CPU 60A. Examples of the various types of information displayed on the display 13a include contents of various instructions received by the reception device 62 and the captured image or imaging information received by the communication I/F 66. The CPU 60A causes the display 13a to display the contents of various instructions received by the reception device 62 and the captured image or imaging information received by the communication I/F 66.

The secondary storage device 14 is, for example, a non-volatile memory and stores various types of information under the control of the CPU 60A. An example of the various types of information stored in the secondary storage device 14 includes the captured image or imaging information received by the communication I/F 66. The CPU 60A stores the captured image or imaging information received by the communication I/F 66 in the secondary storage device 14.

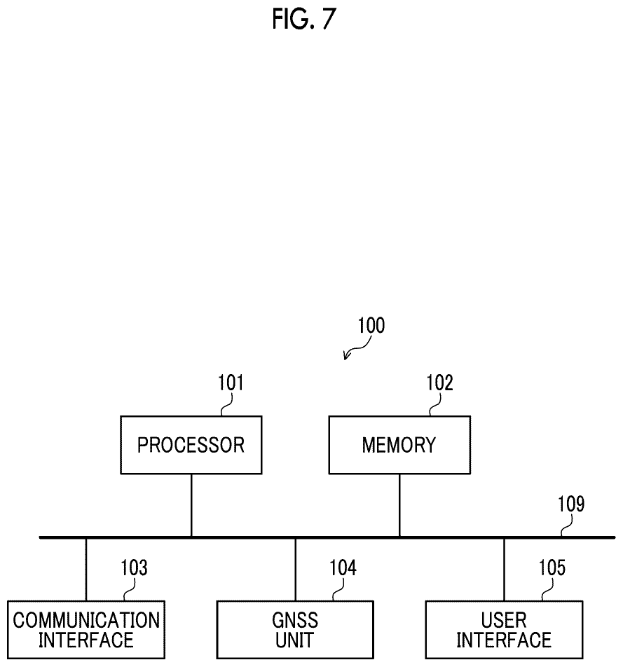

The communication I/F 69 is, for example, a network interface. In a region of a surveillance target (imaging target) by the imaging system 1 (hereinafter, referred to as a “surveillance target region”), a plurality of workers are present, and each worker possesses a terminal device (for example, see FIG. 7) such as a smartphone. The communication I/F 69 directly or indirectly performs communication with the terminal device possessed by each worker in the surveillance target region via the network. The network is, for example, a WAN or a LAN. The surveillance target region is, for example, a place where dangerous work is performed by a plurality of workers, and is an example of a construction site.

### <Image Displayed by Management Apparatus 11>

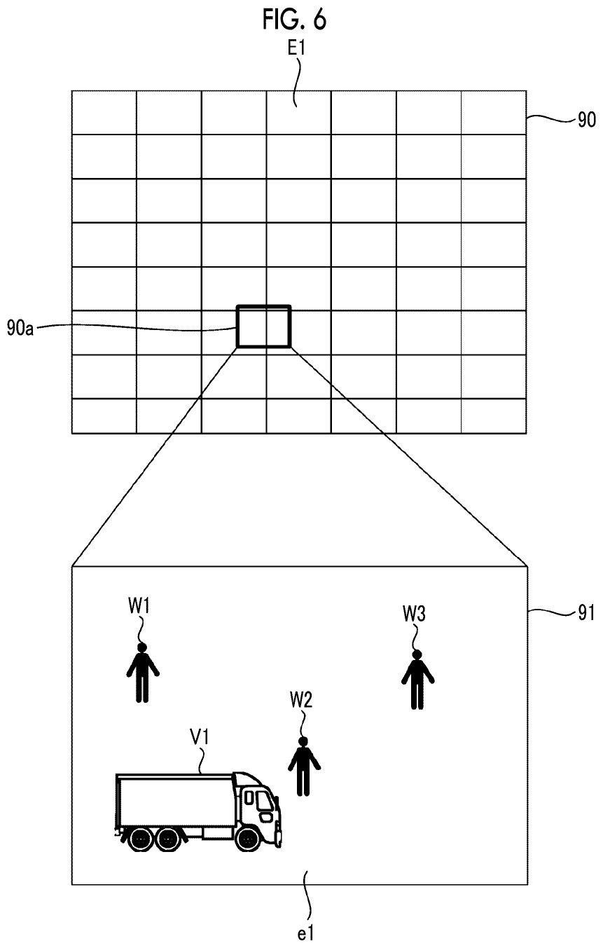

FIG. 6 is a diagram showing an example of an image displayed by the management apparatus 11. The management apparatus 11 can display, for example, the wide area image 90 and the detailed image 91 on the display 13a for a user (for example, surveillant of a surveillance target region) of the management apparatus 11. In this example, it is assumed that the angle of view of the surveillance camera 10 is an angle of view in which only a partial region of the surveillance target region can be imaged.

The wide area image 90 is a pseudo wide-angle image representing the entire surveillance target region E1, which is generated by the management apparatus 11 controlling the surveillance camera 10 and the revolution mechanism 16 to cause the surveillance camera 10 to image each region of the surveillance target region E1 for a plurality of times and to combine (connect) each imaging information obtained by the imaging. This series of imaging control and the generation of the wide area image 90 are performed periodically, for example, at a predetermined time (for example, 7:00 in the morning) every day.

The detailed image 91 is an image that is generated from the latest imaging information obtained by the imaging of the surveillance camera 10 and that represents a partial region e1 of the surveillance target region E1 in real time.

The wide area image 90 and the detailed image 91 may be displayed, for example, simultaneously side by side, or may be displayed by being switched between each other according to an operation or the like from the user of the management apparatus 11.

The wide area image 90 includes a region designation cursor 90a. The user of the management apparatus 11 can change the position or the size of the region designation cursor 90a by operating the reception device 62.

For example, the memory 60C of the management apparatus 11 or the secondary storage device 14 stores correspondence information in which the coordinates of the wide area image 90, the longitude and latitude (longitude and latitude) of the position corresponding to the coordinates in the surveillance target region E1, and the control parameter (control values of the pan and the tilt of the surveillance camera 10) of the revolution mechanism 16 for imaging the surveillance camera 10 with the position corresponding to the coordinates in the surveillance target region E1 as the center are uniquely associated with each other.

For example, the management apparatus 11 derives a correspondence relationship between the coordinates of the wide area image 90 and the control parameter of the revolution mechanism 16 in the generation of the wide area image 90 described above. In addition, for example, the management apparatus 11 adjusts the control parameter of the revolution mechanism 16 such that the surveillance camera 10 can image the plurality of positions included in the surveillance target region E1 and having known longitude and latitude as the center of the position, and derives the correspondence relationship between the control parameter of the revolution mechanism 16 and the longitude and latitude by associating the adjusted control parameter with the longitude and latitude (known) of the position. As a result, it is possible to generate the correspondence information in which the coordinates of the wide area image 90, the control parameter of the revolution mechanism 16, and the longitude and latitude are associated with each other.

In a case where the region designation cursor 90a is set by the operation from the user, the management apparatus 11 acquires the control parameter of the revolution mechanism 16 corresponding to the coordinate of the center of the region designated by the region designation cursor 90a in the wide area image 90 from the correspondence information, and sets the acquired control parameter in the revolution mechanism 16. As a result, the detailed image 91 representing the region in the surveillance target region E1 designated by the region designation cursor 90a by the user of the management apparatus 11 is displayed.

That is, the user of the management apparatus 11 can view the entire surveillance target region E1 by the wide area image 90. In addition, in a case where the user of the management apparatus 11 wants to view the partial region e1 of the surveillance target region E1 in detail, the user can view the detailed image 91, which represents the partial region e1 in detail, by setting the region designation cursor 90a to a part of the partial region e1 in the wide area image 90. In the example shown in FIG. 6, a vehicle V1 and workers W1 to W3 are shown in the detailed image 91.

As described above, by using the real-time imaging information obtained by the surveillance camera 10 and the pseudo wide-angle image generated by combining each imaging information obtained by imaging each region of the surveillance target region E1 with the surveillance camera 10, it is possible to display both the wide area image 90 and the detailed image 91 by the set of the surveillance camera 10 and the revolution mechanism 16.

### <Hardware Configuration of Terminal Device Possessed by Worker in Surveillance Target Region E1>

FIG. 7 is a diagram showing an example of a hardware configuration of the terminal device possessed by the worker in the surveillance target region E1. Each of the workers (for example, the workers W1 to W3) of the surveillance target region E1 possesses, for example, a terminal device 100 shown in FIG. 7. The terminal device 100 comprises a processor 101, a memory 102, a communication interface 103, a global navigation satellite system (GNSS) unit 104, and a user interface 105. The processor 101, the memory 102, the communication interface 103, the GNSS unit 104, and the user interface 105 are connected to each other through, for example, a bus 109.

The processor 101 is a circuit that performs signal processing, and is, for example, a CPU that performs control of the entire terminal device 100. The processor 101 may be implemented by another digital circuit, such as an FPGA or a DSP. In addition, the processor 101 may be implemented by combining a plurality of digital circuits with each other.

The memory 102 includes, for example, a main memory and an auxiliary memory. The main memory is, for example, a RAM. The main memory is used as a work area of the processor 101. The auxiliary memory is, for example, a non-volatile memory such as a magnetic disk, an optical disk, or a flash memory. The auxiliary memory stores various programs for operating the terminal device 100. The programs stored in the auxiliary memory are loaded into the main memory and executed by the processor 101.

In addition, the auxiliary memory may include a portable memory that can be detached from the terminal device 100. Examples of the portable memory include a memory card such as a universal serial bus (USB) flash drive or a secure digital (SD) memory card, an external hard disk drive, and the like.

The communication interface 103 is a communication interface that performs wireless communication with an outside of the terminal device 100. For example, the communication interface 103 indirectly performs communication with the management apparatus 11 by being connected to the Internet via the moving object communication network. The communication interface 103 is controlled by the processor 101.

The GNSS unit 104 is, for example, a satellite positioning system such as a global positioning system (GPS), and acquires position information (longitude and latitude) of the terminal device 100. The GNSS unit 104 is controlled by the processor 101.

The user interface 105 includes, for example, an input device that receives an operation input from the user, and an output device that outputs information to the user. The input device can be implemented by, for example, a key (for example, a keyboard) or a remote controller. The output device can be implemented by, for example, a display or a speaker. In addition, the input device and the output device may be implemented by a touch panel or the like. The user interface 105 is controlled by the processor 101.

### <Process by Management Apparatus 11>

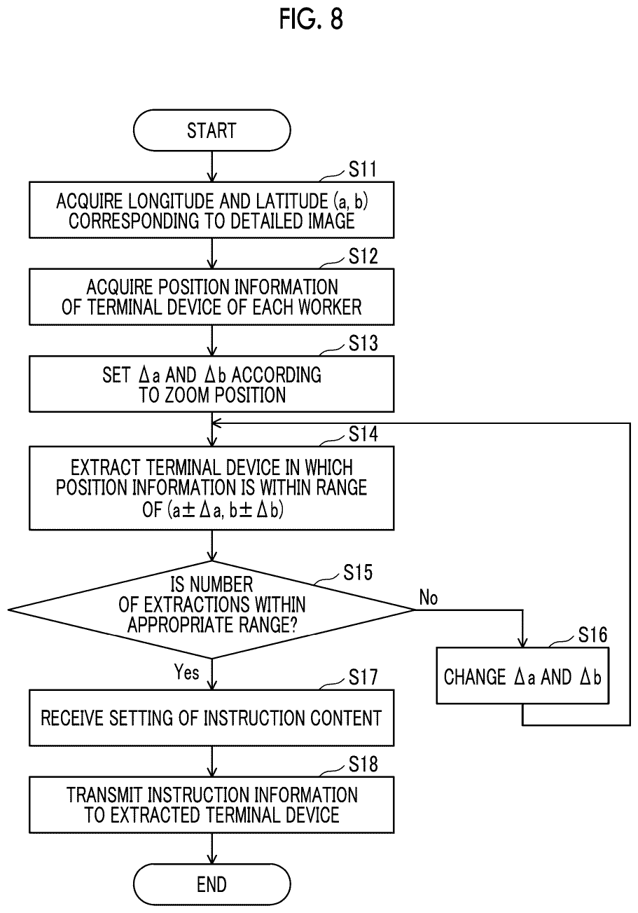

FIG. 8 is a flowchart showing an example of a process by the management apparatus 11. As described above, the management apparatus 11 stores the correspondence information in which the coordinates of the wide area image 90, the control parameter of the revolution mechanism 16, and the longitude and latitude are associated with each other. The management apparatus 11 executes, for example, the process shown in FIG. 8 in response to the instruction information transmission operation from the user in a state in which the detailed image 91 is displayed.

First, the management apparatus 11 acquires the longitude and latitude corresponding to the current detailed image 91 (step S11). The longitude and latitude corresponding to the detailed image 91 is the position information of the imaging target (partial region e1) associated with the captured image (detailed image 91) captured by the imaging system (surveillance camera 10 and revolution mechanism 16), and is an example of first position information according to the embodiment of the present invention. The longitude and latitude corresponding to the detailed image 91 is, for example, the longitude and latitude of a point shown at the center of the detailed image 91. For example, the management apparatus 11 acquires the longitude and latitude corresponding to the current control parameter of the revolution mechanism 16 as the longitude and latitude corresponding to the current detailed image 91 based on the correspondence information described above. The longitude of the acquired longitude and latitude in step S11 is denoted by a, and the latitude of the acquired longitude and latitude in step S11 is denoted by b.

Next, the management apparatus 11 acquires the position information of the terminal device 100 of each worker in the surveillance target region E1 (step S12). The position information is position information of the terminal device 100 obtained by the terminal device 100 in the imaging region (surveillance target region E1) of the imaging system (surveillance camera 10 and revolution mechanism 16), and is an example of second position information according to the embodiment of the present invention.

For example, the terminal device 100 of each worker in the surveillance target region E1 repeatedly transmits the position information of the terminal device 100 acquired by the GNSS unit 104 of the terminal device 100 to the management apparatus 11. On the other hand, in step S12, the management apparatus 11 acquires the latest position information from the received position information for each of the terminal devices 100 of each worker in the surveillance target region E1.

Alternatively, in step S12, the management apparatus 11 may transmit a request signal for requesting the transmission of the position information to the terminal device 100 of each worker in the surveillance target region E1, and may acquire the position information transmitted from the terminal device 100 in response to the request signal.

Next, the management apparatus 11 determines the zoom position (focal length or zoom magnification) of the surveillance camera 10 based on the control parameter set for the surveillance camera 10, and sets Δa and Δb according to the determined zoom position (step S13). For example, the management apparatus 11 sets Δa and Δb to be larger as the zoom position is wider.

Next, the management apparatus 11 extracts the terminal device 100 in which the longitude and latitude indicated by the position information acquired in step S12 is within the range of (a±Δa, b±Δb) from the terminal device 100 of each worker in the surveillance target region E1 based on the longitude and latitude (a, b) acquired in step S11 and the Δa and Δb currently set (step S14). The range of (a±Δa, b±Δb) is a range in which the longitude is from a−Δa to a+Δa and is a rectangular range in which the latitude is from b−Δb to b±Δb. It should be noted that the range that is the determination criterion of step S14 is not limited to the rectangular range of (a±Δa, b±Δb), and may be a range of another shape, such as a circular range having a radius A with the longitude and latitude (a, b) as the center.

Next, the management apparatus 11 determines whether or not the number of the terminal devices 100 extracted in step S14 (the number of extractions) is within a predetermined appropriate range (step S15). The appropriate range is, for example, a range set in advance. In a case where the number of extractions is not within the appropriate range (step S15: No), the management apparatus 11 changes Δa and Δb (step S16), and returns to step S14.

In step S16, the management apparatus 11 changes Δa and Δb by, for example, notifying the user of the number of extractions by the display 13a or the like and receiving the instruction to increase or decrease Δa and Δb from the user. For example, in a case where the appropriate range is a range of one or more and the number of extractions is zero, the management apparatus 11 notifies the user that the number of extractions is zero, and receives the instruction on how much to increase Δa and Δb from the reception device 62. In addition, in step S16, the management apparatus 11 may notify the user of the information such as the name, the affiliation, and the mail address of the possessor of the terminal device 100 extracted in step S14, in addition to the number of extractions. In addition, in step S16, the management apparatus 11 may perform a process of increasing Δa and Δb in a case where the number of extractions is below the appropriate range and decreasing Δa and Δb in a case where the number of extractions is above the appropriate range, without receiving the instruction from the user.

In step S15, in a case where the number of extractions is within the appropriate range (step S15: Yes), the management apparatus 11 receives the setting of the instruction content with respect to the possessor of the terminal device 100 extracted in step S14 from the user of the management apparatus 11 (step S17). The instruction content is text information, an image, audio, a combination thereof, or the like. For example, the instruction content is a combination of the detailed image 91 (real-time image) and the text information input by the user in step S15 (for example, a message such as “Please be careful because the vehicle nearby moves”).

In addition, in step S17, the management apparatus 11 may notify the user of the default instruction content. In addition, in step S17, the management apparatus 11 may display the information such as the name, the affiliation, the mail address of the possessor of the terminal device 100 extracted in step S14, and input control such as a check box (all are “on” in a default state) that can designate whether or not to transmit by on/off for each of the possessors. The terminal device 100 in which the check box is set to “off” is excluded from the transmission destination of the instruction information in step S18 described below.

Next, the management apparatus 11 transmits the instruction information on the instruction content received in step S17 to the terminal device 100 extracted in step S14 (step S18), and ends the series of processes. The instruction information is an example of first data according to the embodiment of the present invention. For example, the management apparatus 11 sets the mail address of the terminal device 100 extracted in step S14 as the destination, generates an electronic mail in which the instruction content received in step S17 is set as subject or main text, and transmits the generated electronic mail via the communication I/F 69.

The terminal device 100, which received the instruction information transmitted in step S18, reproduces (for example, displays) the instruction content of the received instruction information.

Although a case has been described where the appropriate range in step S15 of FIG. 8 is set in advance, the appropriate range may be set based on, for example, the detailed image 91. For example, in the process of FIG. 8, the management apparatus 11 may detect the number of the workers shown in the detailed image 91 by the image recognition process based on the detailed image 91, and may set the appropriate range in step S15 based on the detected number.

For example, in a case where the detected number is denoted by N, the management apparatus 11 sets a range from N−ΔNa to N+ΔNb as the appropriate range. However, in a case where N−ΔNa is less than 0, the management apparatus 11 sets a range from 0 to N+ΔNb as the appropriate range. The values of ΔNa and ΔNb are set in advance.

For example, by setting the region designation cursor 90a in the wide area image 90 at a place where danger occurs (for example, a place where the vehicle V1 moves) and performing the instruction information transmission operation, the user of the management apparatus 11 can notify the worker (for example, the workers W1 to W3) who is in the vicinity of the place of the instruction content to prompt the worker to pay attention or to retreat.

As described above, the management apparatus 11 of Embodiment 1 acquires the first position information of the imaging target (partial region e1) associated with the captured image (detailed image 91) captured by the imaging system (for example, surveillance camera 10 and revolution mechanism 16), and the second position information of the terminal device (for example, the terminal device 100 of the moving object such as the workers W1 to W3 included in the captured image) obtained by the terminal device in the imaging region (surveillance target region E1) of the imaging system, and generates the instruction information (first data) in which the transmission destination is set based on the acquired first position information and second position information.

Specifically, the management apparatus 11 acquires the longitude and latitude (second position information) for the plurality of terminal devices 100 present in the surveillance target region E1, extracts the terminal device 100 of which the acquired longitude and latitude is included in the range based on the longitude and latitude (first position information) corresponding to the detailed image 91, and generates and transmits the instruction information (first data) in which the extracted terminal device 100 is set as a transmission destination.

As a result, the instruction information can be efficiently transmitted to the person (for example, workers W1 to W3) in the specific region (for example, partial region e1) in the surveillance target region E1 by utilizing the first position information of the imaging target (the partial region e1) associated with the captured image (the detailed image 91) and the second position information obtained by the terminal device 100.

In addition, the management apparatus 11 may set the range of the terminal device 100 to be extracted as the transmission destination based on the zoom information of the imaging system (for example, surveillance camera 10) in addition to the longitude and latitude (first position information) corresponding to the detailed image 91. For example, the management apparatus 11 sets the range of the terminal device 100 to be extracted as the transmission destination to be wider (for example, Δa and Δb described above to be larger) as the zoom position of the surveillance camera 10 is a wider zoom position. As a result, since the terminal device 100 located in the range according to the width of the range viewed by the user of the management apparatus 11 through the detailed image 91 can be set as the transmission destination, the user of the management apparatus 11 can easily transmit the instruction information to the worker (for example, workers W1 to W3) intended by the user.

In addition, the management apparatus 11 may set the range of the terminal device 100 to be extracted as the transmission destination based on the number of the moving objects (for example, workers W1 to W3) having the terminal device 100 detected from the detailed image 91 (captured image) in addition to the longitude and latitude (first position information) corresponding to the detailed image 91. For example, the management apparatus 11 sets the appropriate range based on the number of the workers detected from the detailed image 91, and performs a process of changing the range (for example, Δa and Δb described above) of the terminal device 100 to be extracted as the transmission destination such that the extraction range of the terminal device 100 is the appropriate range. As a result, in a case where the difference between the number of extractions of the terminal device 100 and the number of the workers shown in the detailed image 91 that the user of the management apparatus 11 was viewing at in a case of transmitting the instruction information is large, the difference can be reduced.

### Modification Example 1 of Imaging System 1

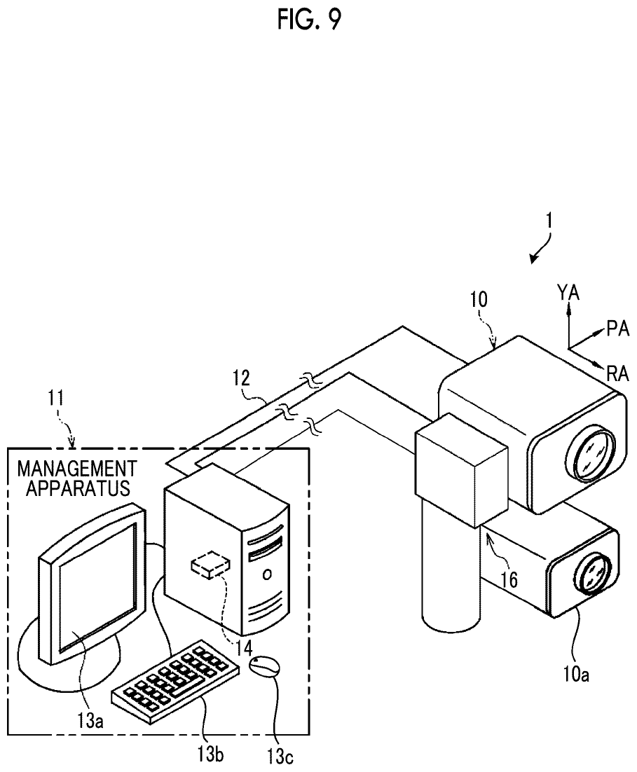

FIG. 9 is a diagram showing Modification Example 1 of the imaging system 1. As shown in FIG. 9, the imaging system 1 may include a surveillance camera 10a in addition to the configuration shown in FIG. 1. The surveillance camera 10a is a camera having a wider angle of view than the surveillance camera 10 and is installed to be able to image the entire surveillance target region E1. The configuration of the surveillance camera 10a is the same as the configuration of the surveillance camera 10 shown in FIG. 4, for example, but is different in that the optical system 15 has a wider angle optical characteristic.

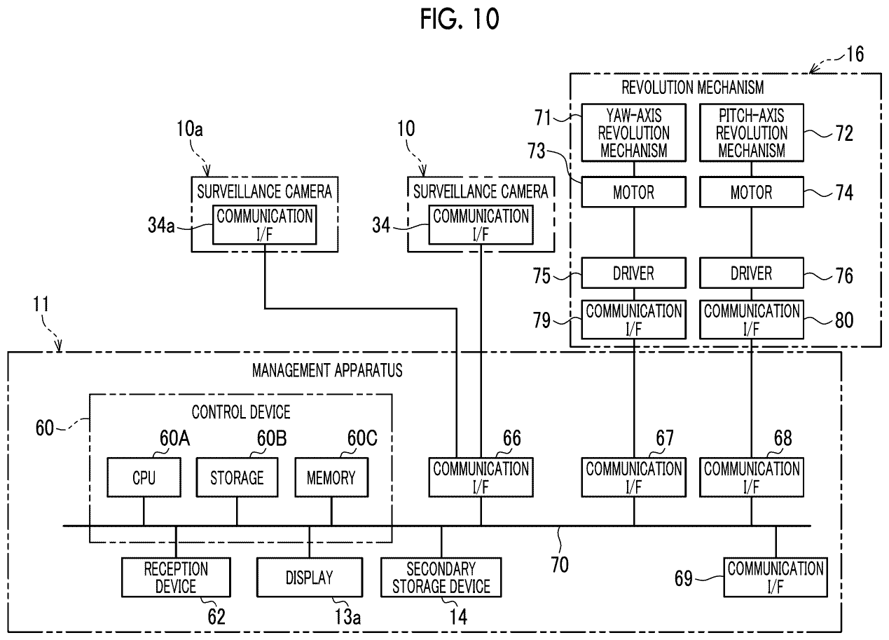

FIG. 10 is a diagram showing an example of a configuration of the electrical system of the management apparatus 11 shown in FIG. 9. In the imaging system 1 shown in FIG. 9, the surveillance camera 10a comprises a communication I/F 34a similar to the communication I/F 34 of the surveillance camera 10. The communication I/F 34a performs communication between the surveillance camera 10a and the management apparatus 11.

The communication I/F 66 of the management apparatus 11 is communicably connected to the communication I/F 34a of the surveillance camera 10a in addition to the communication I/F 34 of the surveillance camera 10, and controls transmission of various types of information to and from the surveillance cameras 10 and 10a.

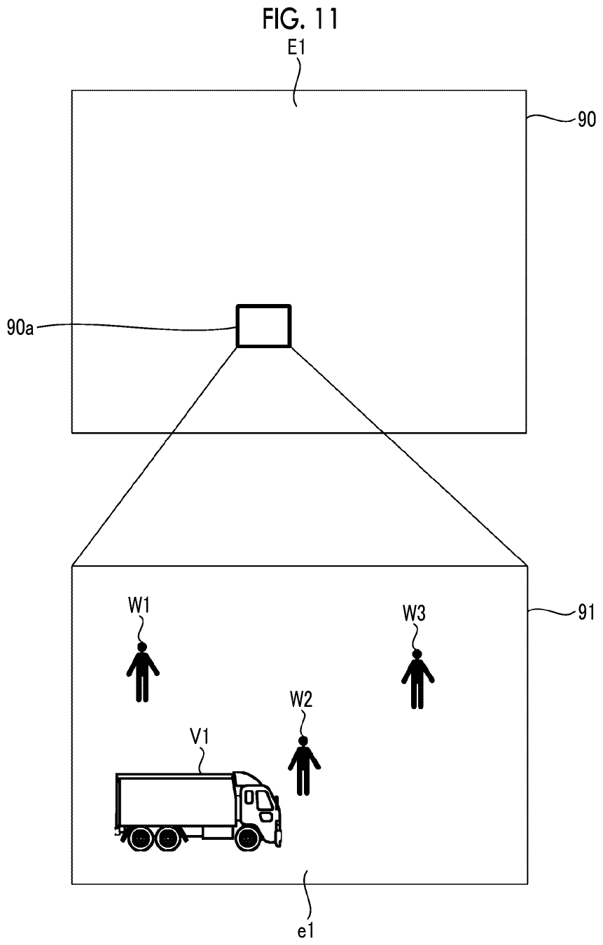

FIG. 11 is a diagram showing an example of an image displayed by the management apparatus 11 in configurations shown in FIGS. 9 and 10. In the configurations shown in FIGS. 9 and 10, the management apparatus 11 displays an image based on the imaging information obtained from the surveillance camera 10a as the wide area image 90 representing the surveillance target region E1. That is, the wide area image 90 in this case is not the pseudo wide-angle image generated by combining each imaging information obtained by imaging each region of the surveillance target region E1 with the surveillance camera 10, but is the wide-angle image based on the single imaging information obtained by the wide-angle surveillance camera 10a.

In this case, the wide area image 90 may be a non-real-time image obtained by the periodical imaging as described above, or may be a real-time image obtained from the latest imaging information obtained by the imaging of the surveillance camera 10a.

In this case as well, the management apparatus 11 stores the correspondence information in which the coordinates of the wide area image 90, the control parameter of the revolution mechanism 16, and the longitude and latitude, which are described above, are uniquely associated with each other. In this case, the control parameter of the revolution mechanism 16 and the coordinates of the wide area image 90 corresponding to the longitude and latitude are derived, for example, by the user of the management apparatus 11 designating the coordinates corresponding to the wide area image 90 for a plurality of positions included in the surveillance target region E1 and having known longitude and latitude. The management apparatus 11 executes the process shown in FIG. 8 by using the correspondence information.

### Modification Example 2 of Imaging System 1

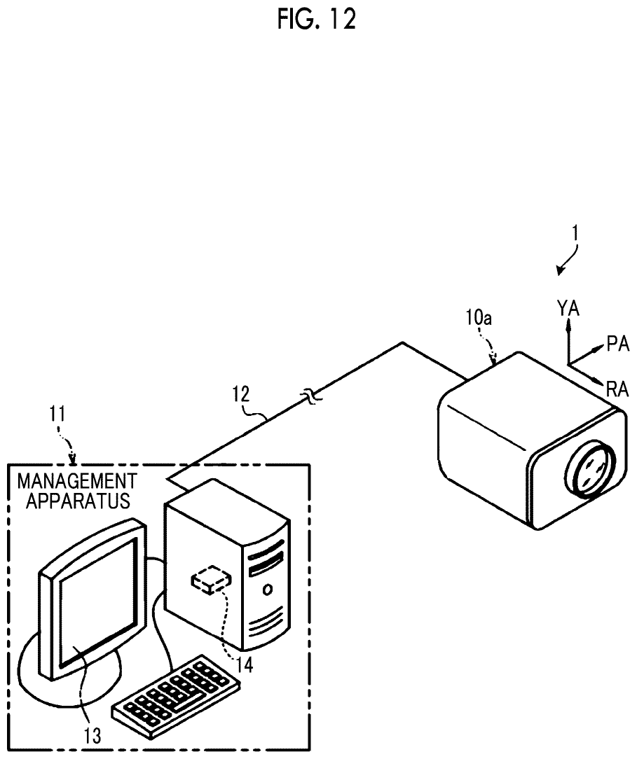

FIG. 12 is a diagram showing Modification Example 2 of the imaging system 1. As shown in FIG. 12, the imaging system 1 may have a configuration in which the surveillance camera 10 and the revolution mechanism 16 are omitted from the configuration shown in FIG. 9.

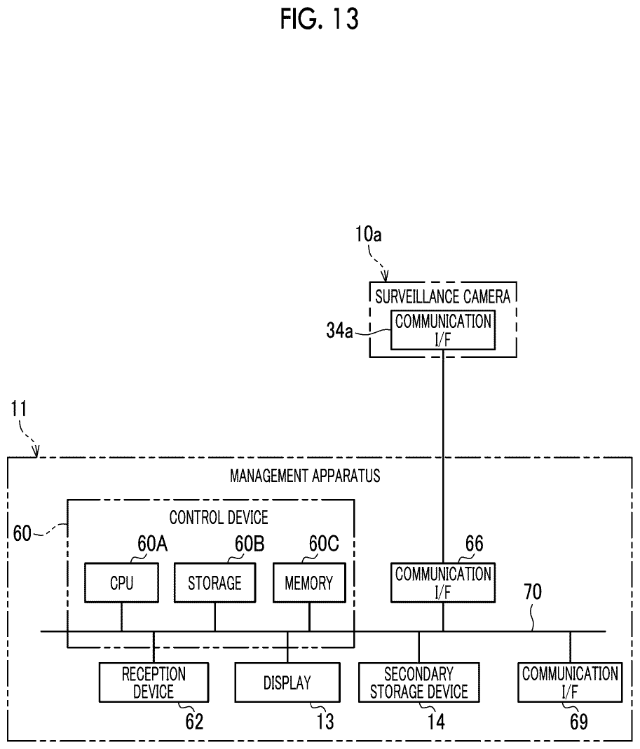

FIG. 13 is a diagram showing an example of a configuration of the electrical system of the management apparatus 11 shown in FIG. 12. In the imaging system 1 shown in FIG. 12, the management apparatus 11 has a configuration in which the communication I/F 67 and the communication I/F 68 are omitted in the configuration shown in FIG. 10. The communication I/F 66 of the management apparatus 11 is communicably connected to the communication I/F 34a of the surveillance camera 10a, and controls transmission of various types of information to and from the surveillance camera 10a.

The image displayed by the management apparatus 11 in the configurations shown in FIGS. 12 and 13 is the same as the wide area image 90 and the detailed image 91 shown in FIG. 11, for example. However, the management apparatus 11 displays a digital zoom image obtained by cutting out and enlarging a region designated by the region designation cursor 90a in the wide area image 90 as the detailed image 91 representing the partial region e1. In this case, the wide area image 90 is, for example, a real-time image obtained from the latest imaging information obtained by the imaging of the surveillance camera 10a.

In this case, the management apparatus 11 stores the correspondence information in which the coordinates of the wide area image 90 and the longitude and latitude are uniquely associated with each other. That is, in the correspondence information in this case, the control parameter of the revolution mechanism 16 is not necessary. In this case, the coordinates of the wide area image 90 corresponding to the longitude and latitude are derived, for example, by the user of the management apparatus 11 designating the coordinates corresponding to the wide area image 90 for a plurality of positions included in the surveillance target region E1 and having known longitude and latitude.

The management apparatus 11 executes the process shown in FIG. 8 by using the correspondence information. In this case, in step S11, the management apparatus 11 acquires the longitude and latitude corresponding to the detailed image 91 based on the coordinates of the region subjected to the digital zoom in the wide area image 90 and the correspondence information. In addition, in step S13, the management apparatus 11 sets Δa and Δb according to the digital zoom amount of the detailed image 91.

### <Checking Processing of Person in Poor Physical Condition, Injured Person, or the Like>

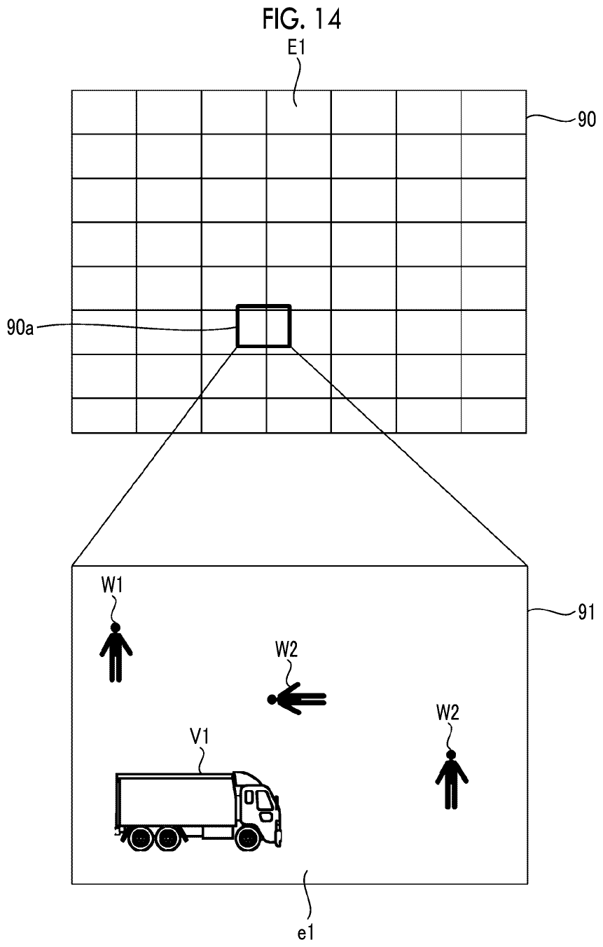

FIG. 14 is a diagram showing an example of a checking processing of a person in poor physical condition, an injured person, or the like. The imaging system 1 can also be applied to a system that can check a worker who has fallen down or cannot move due to heat stroke, injury, or the like in a surveillance target region E1 (for example, a construction site).

For example, each of the terminal devices 100 detects an abnormality of the worker who possesses the terminal device 100. The detection of the abnormality of the worker is performed based on, for example, at least any one of the fact that a state in which there is no variation in the longitude and latitude acquired by the GNSS unit 104 provided in the terminal device 100 has continued for a certain time or longer, the fact that a stationary state of the terminal device 100 detected by the acceleration sensor provided in the terminal device 100 has continued for a certain time or longer, or the fact that the biological information of the worker measured by the wearable device that is communicable with the terminal device 100 and worn by the worker is an abnormal value.

In this case, the terminal device 100 transmits abnormality detection information indicating that the abnormality of the worker is detected to the management apparatus 11 together with information on the longitude and latitude acquired by the GNSS unit 104 provided in the terminal device 100. In a case where the abnormality detection information and the information on the longitude and latitude are received, the management apparatus 11 displays the detailed image 91 of the region of the wide area image 90 corresponding to the longitude and latitude. As a result, in a case where the abnormality of the worker is detected by the terminal device 100, the detailed image 91 showing the position of the worker can be automatically displayed. Therefore, the user of the management apparatus 11 can quickly check the state of the worker in which the abnormality is detected.

In the state shown in FIG. 14, the worker W2 falls down in the partial region e1, and the terminal device 100 possessed by the worker W2 transmits the abnormality detection information and the information on the longitude and latitude to the management apparatus 11. In this case, the management apparatus 11 displays the detailed image 91 of the partial region e1 based on the information on the longitude and latitude received together with the abnormality detection information. As a result, the user of the management apparatus 11 can quickly check the state in which the worker W2 has fallen down.

Further, the user of the management apparatus 11 can transmit the instruction information inquiring about the situation to the worker W2 or transmit the instruction information for instructing rescue or the like to other workers W1 and W2 around the worker W2 by performing the instruction information transmission operation described above in a state in which the detailed image 91 showing the worker W2 is displayed.

### Modification Example of Instruction Information

Although the electronic mail has been described as the instruction information, which is an example of the first data, the instruction information is not limited to the electronic mail, and can be various types of message information, such as a short message service (SMS) or a message by a messenger application.

### Embodiment 2

Parts of Embodiment 2 different from Embodiment 1 will be described. The imaging system 1 of Embodiment 2 has the same configuration as the imaging system 1 shown in FIGS. 1 to 5, for example, and can display the wide area image 90 and the detailed image 91 on the display 13a in the same manner as in the example shown in FIG. 6.

### Process by Management Apparatus 11 of Embodiment 2

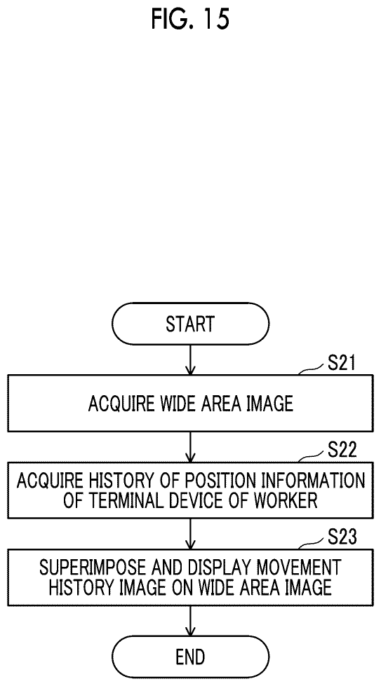

FIG. 15 is a flowchart showing an example of a process by the management apparatus 11 of Embodiment 2. It is assumed that the management apparatus 11 of Embodiment 2 stores the wide area image 90, which is the pseudo wide-angle image, in the secondary storage device 14 in association with a generation time point of the wide area image 90. For example, the management apparatus 11 generates the wide area image 90 at a predetermined time every day, and stores the generated wide area image 90 in the secondary storage device 14 in association with a date and time of the generation.

The management apparatus 11 of Embodiment 2 executes the process shown in FIG. 15, for example, according to an operation from the user.

First, the management apparatus 11 acquires the wide area image 90 (step S21). The wide area image 90 is, for example, a pseudo wide-angle image generated by imaging each region of the surveillance target region E1 with the surveillance camera 10 and combining each imaging information obtained by the imaging.

Next, the management apparatus 11 acquires a history of the position information of the terminal device 100 of the worker in the surveillance target region E1 (step S22). The history of the position information of the terminal device 100 is, for example, the longitude and latitude of the terminal device 100 at each of a plurality of time points. For example, the terminal device 100 of the worker in the surveillance target region E1 repeatedly transmits the position information of the own device acquired by the GNSS unit 104 of the own device to the management apparatus 11. On the other hand, the management apparatus 11 acquires the history of the position information of the terminal device 100 in step S12 by accumulating the position information received from the terminal device 100 of the worker in the surveillance target region E1.

Alternatively, in step S22, the management apparatus 11 may transmit a request signal for requesting the transmission of the history of the position information to the terminal device 100 of the worker in the surveillance target region E1, and may acquire the history of the position information transmitted from the terminal device 100 in response to the request signal. Next, the management apparatus 11 superimposes and displays, on the wide area image 90 acquired in step S21, the movement history image indicating the history of the position information of the terminal device 100 acquired in step S22 (step S23), and ends the series of processes. The movement history image is an example of information related to a movement history of a moving object according to the embodiment of the present invention.

It should be noted that the worker who is the target of the process shown in FIG. 15 may be all the workers who are present in the surveillance target region E1 and possess the terminal device 100, or may be some of the workers (for example, worker W1). The worker who is the target of the process shown in FIG. 15 may be designated by the user of the management apparatus 11.

<Display of Wide Area Image 90 on which Movement History Image is Superimposed>

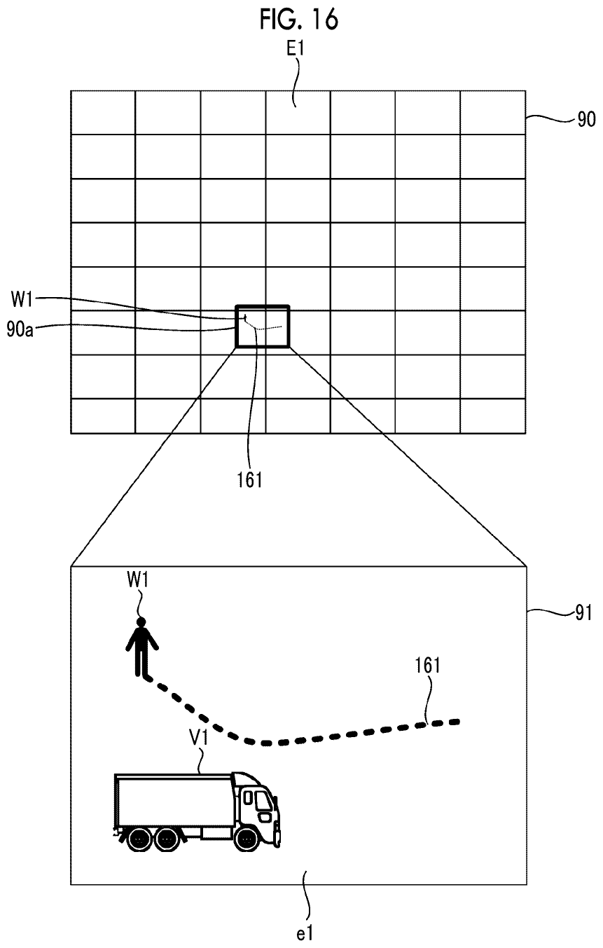

FIG. 16 is a diagram showing an example of a display of the wide area image 90 on which the movement history image is superimposed. In the example of FIG. 16, a case will be described in which the process shown in FIG. 15 is performed on the worker W1 as the target. In step S23 shown in FIG. 15, the management apparatus 11 displays, on the display 13a, the wide area image 90 on which the movement history image 161 is superimposed, for example, as shown in the wide area image 90 of FIG. 16. The movement history image 161 is an image showing a history of the position information acquired from the terminal device 100 possessed by the worker W1.

For example, the management apparatus 11 specifies each coordinate corresponding to the longitude and latitude for each time point indicated by the history of the position information in the wide area image 90 based on the correspondence information in which the coordinates of the wide area image 90 and the longitude and latitude are associated with each other. Then, the management apparatus 11 superimposes and displays the movement history image 161 on the wide area image 90 by drawing a line to connect each of the specified coordinate in time series of the history of the position information.

The wide area image 90 on which the movement history image 161 is superimposed may be a latest wide area image 90 (latest image) among the wide area images 90 stored in the management apparatus 11, or may be a wide area image 90 (time point history correspondence image) corresponding to the time point (for example, the first or last time point) of the history indicated by the movement history image 161 among the wide area images 90 stored in the management apparatus 11.

In addition, the management apparatus 11 may display the detailed image 91 on which the movement history image 161 is superimposed in the same manner as the wide area image 90 according to an operation or the like from the user. The detailed image 91 in this case may be a digital zoom image in which a region designated by the region designation cursor 90a in the wide area image 90 on which the movement history image 161 is superimposed is cut out and enlarged (pseudo wide-angle image mode), or may be an image in which the movement history image 161 is superimposed on a real-time image based on the captured image obtained by controlling the revolution mechanism 16 and the surveillance camera 10 to image the designated region by the region designation cursor 90a (real-time video mode).

In addition, the detailed image 91 may be a pseudo wide-angle image generated by imaging each partial region of a region including the designated region designated by the region designation cursor 90a and is wider than the designated region with the surveillance camera 10 and combining each imaging information obtained by the imaging. As a result, the detailed image 91 representing a range wider than the angle of view of the surveillance camera 10 (however, narrower than the wide area image 90) can be displayed. Therefore, it is possible to suppress a situation in which the angle of view of the surveillance camera 10 is too narrow to display the movement history image 161 as the detailed image 91. In addition, the management apparatus 11 may set the “region including the designated region and is wider than the designated region” to include the position of each longitude and latitude included in the history of the position information.

In addition, the management apparatus 11 may receive setting of a period (for example, a start time and an end time) of a history of the position information of the display target from the user. For example, the management apparatus 11 displays a time bar on the display 13a, and receives the setting of the period of the history of the position information of the display target by the reception device 62 receiving the setting of the pointer position of the time bar. In this case, in step S22 shown in FIG. 15, the management apparatus 11 acquires the history of the position information in the period designated by the user.

In addition, a case where the process shown in FIG. 15 is performed on the worker W1 as the target has been described, but the management apparatus 11 may receive a selection of the worker who is the processing target in FIG. 15 among the workers who possess the terminal device 100 present in the surveillance target region E1. The selection of the worker may be performed by individually designating the worker or by designating a group (for example, a company or a department) to which the worker belongs.

As described above, the management apparatus 11 of Embodiment 2 acquires the first position information of the imaging target (surveillance target region E1) associated with the captured image (wide area image 90) captured by the imaging system (for example, surveillance camera 10 and revolution mechanism 16), and the second position information of the terminal device (for example, the terminal device 100 of the moving object such as the workers W1 to W3 included in the captured image) obtained by the terminal device in the imaging region (surveillance target region E1) of the imaging system, and generates the image (first data) obtained by superimposing the movement history image 161 indicating the movement history of the worker on at least any one of the wide area image 90 or the detailed image 91 based on the acquired first position information and second position information.

As a result, it is possible to display the image in which the movement history of the worker in the surveillance target region E1 can be easily checked by utilizing the first position information of the imaging target (surveillance target region E1) associated with the captured image (wide area image 90) and the second position information obtained by the terminal device 100. Therefore, for example, it is easy to specify that the worker has entered a dangerous place, to determine whether or not the worker has acted in accordance with a predetermined procedure, or to analyze a cause in a case where an accident has occurred.

### Modification Example 1 of Imaging System 1 of Embodiment 2

The imaging system 1 of Embodiment 2 may have configurations shown in FIGS. 9 and 10, for example.

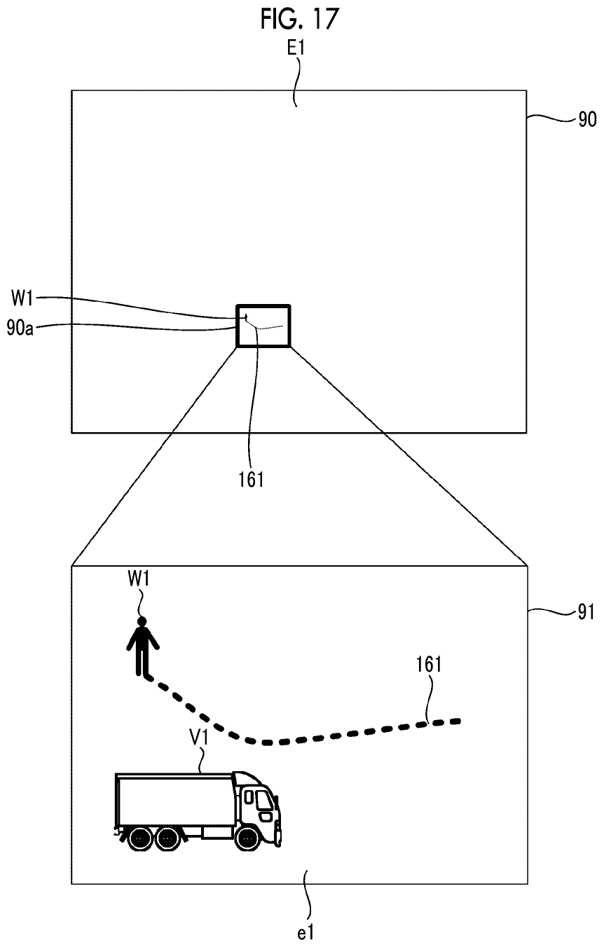

FIG. 17 is a diagram showing an example of an image displayed by the management apparatus 11 in a case where a configuration of the imaging system 1 of Embodiment 2 is the configurations shown in FIGS. 9 and 10. In the configurations shown in FIGS. 9 and 10, the management apparatus 11 of Embodiment 2 displays the image based on the imaging information obtained from the surveillance camera 10a as the wide area image 90 representing the surveillance target region E1, in the same manner as the example of FIG. 11.

In this case as well, the management apparatus 11 stores the correspondence information described above in which the coordinates of the wide area image 90 and the longitude and latitude are associated with each other. The management apparatus 11 executes the process shown in FIG. 15 by using the correspondence information.

### Modification Example 2 of Imaging System 1 of Embodiment 2

The imaging system 1 of Embodiment 2 may have configurations shown in FIGS. 12 and 13, for example. In this case, the image displayed by the management apparatus 11 is the same as the wide area image 90 and the detailed image 91 shown in FIG. 17, for example. However, the management apparatus 11 displays a digital zoom image obtained by cutting out and enlarging a region designated by the region designation cursor 90a in the wide area image 90 as the detailed image 91 representing the partial region e1. In this case as well, the management apparatus 11 stores the correspondence information in which the coordinates of the wide area image 90 and the longitude and latitude are associated with each other. The management apparatus 11 executes the process shown in FIG. 15 by using the correspondence information.

### Modification Example of Moving Object

In Embodiments 1 and 2, a person (workers W1 to W3) is described as an example of a moving object having the terminal device 100, but the moving object having the terminal device 100 is not limited to the person, and may be a moving object that moves together with the terminal device 100, such as a vehicle (for example, the vehicle V1) provided with the terminal device 100.

### <Storage Medium of Information Processing Program>

In each of the operation control examples described above, the example has been described in which the information processing program of each embodiment is stored in the storage 60B of the management apparatus 11 and the CPU 60A of the management apparatus 11 executes the information processing program in the memory 60C, but the technique of the present disclosure is not limited to this.

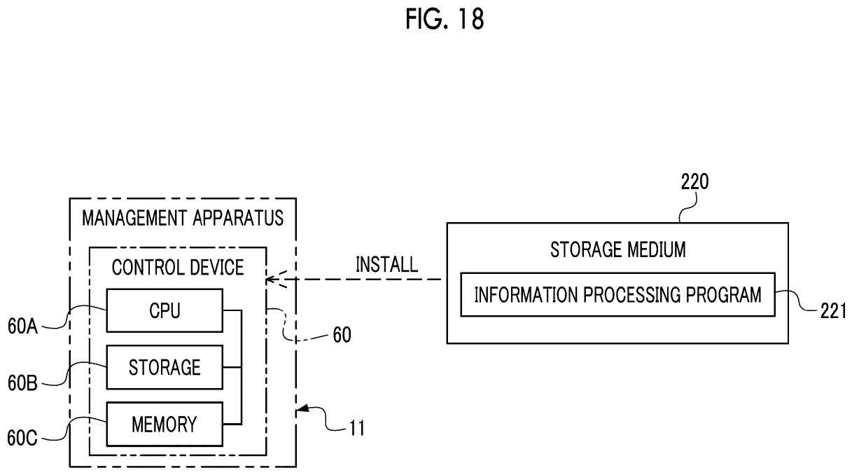

FIG. 18 is a diagram showing an example of an aspect in which the information processing program of an operation control example is installed in the control device 60 of the management apparatus 11 from a storage medium in which the information processing program is stored. As shown in FIG. 18 as an example, an information processing program 221 may be stored in a storage medium 220 which is a non-temporary storage medium. In a case of the example shown in FIG. 18, the information processing program 221 stored in the storage medium 220 is installed in the control device 60, and the CPU 60A executes each of the above-described processing according to the information processing program 221.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-088615) filed on May 31, 2022, the content of which is incorporated in the present application by reference.

### EXPLANATION OF REFERENCES

1: imaging system
10, 10a: surveillance camera
11: management apparatus
12: communication line
13a, 43B: display
13b: keyboard
13c: mouse
14: secondary storage device
15: optical system
15B: lens group
15B1: anti-vibration lens
15B2: zoom lens
16: revolution mechanism
17, 21: lens actuator
19: computer
22, 23, 75, 76: driver
22: BIS driver
23: OIS driver
25: imaging element
25A: light-receiving surface
27: imaging element actuator
28: lens driver
29, 45: correction mechanism
31: DSP
32: image memory
33: correction unit
34, 34a, 66 to 69, 79, 80: communication I/F
35, 60C, 102: memory
36, 60B: storage
37, 60A: CPU
38, 70, 109: bus
39, 47: position sensor
40: shake amount detection sensor
43: UI system device
43A, 62: reception device
60: control device
71: yaw-axis revolution mechanism
72: pitch-axis revolution mechanism
73, 74: motor
90: wide area image
90a: region designation cursor
91: detailed image
100: terminal device
101: processor
103: communication interface
104: GNSS unit
105: user interface
161: movement history image
220: storage medium
221: information processing program
E1: surveillance target region
e1: partial region
V1: vehicle
W1 to W3: worker

What is claimed is:

1. An information processing apparatus comprising:
a processor,
wherein the processor is configured to:
acquire first position information of an imaging target position associated with a captured image captured by an imaging system and second position information of a plurality of terminal devices obtained by the plurality of terminal devices in an imaging region of the imaging system; and
derive a range based on the first position information, extract a terminal device, among the plurality of terminal devices, of which the second position information is included in the derived range, and generate instruction information for which the extracted terminal device is set as a transmission destination.

2. The information processing apparatus according to claim 1,
wherein each of the plurality of terminal devices is a terminal device which a moving object included in the captured image has.

3. The information processing apparatus according to claim 1,
wherein the processor is configured to set the range based on the first position information and zoom information of the imaging system.

4. The information processing apparatus according to claim 1,
wherein the processor is configured to set the range based on the first position information and number of moving objects each having a respective one of the plurality of terminal devices, the number of moving objects being detected from the captured image.

5. The information processing apparatus according to claim 1,
wherein the processor is configured to, in a case where information indicating an abnormality of a possessor of one of the plurality of terminal devices is received from the terminal device, perform control of displaying, on a display device, the captured image showing a region of the imaging region indicated by the second position information.

6. The information processing apparatus according to claim 1,
wherein the processor is configured to perform control of displaying, on a display device, a wide area image showing the imaging region and a detailed image showing a range narrower than the wide area image in the imaging region at a higher magnification than the wide area image.

7. The information processing apparatus according to claim 1,
wherein the imaging system includes an imaging apparatus that obtains the captured image by imaging and a revolution mechanism that revolves the imaging apparatus, and
the first position information is associated with information indicating a revolution state of the imaging apparatus by the revolution mechanism in a case where the captured image is obtained by the imaging system.

8. An information processing method comprising:
via a processor of an information processing apparatus,
acquiring first position information of an imaging target position associated with a captured image captured by an imaging system and second position information of a plurality of terminal devices obtained by the plurality of terminal devices in an imaging region of the imaging system; and
deriving a range based on the first position information, extracting a terminal device, among the plurality of terminal devices, of which the second position information is included in the derived range, and generating instruction information for which the extracted terminal device is set as a transmission destination.

9. A non-transitory computer readable medium storing an information processing program causing a processor of an information processing apparatus to execute a process comprising:
acquiring first position information of an imaging target position associated with a captured image captured by an imaging system and second position information of a plurality of terminal devices obtained by the plurality of terminal devices in an imaging region of the imaging system; and
deriving a range based on the first position information, extracting a terminal device, among the plurality of terminal devices, of which the second position information is included in the derived range, and generating instruction information for which the extracted terminal device is set as a transmission destination.
